(19) United States
(12) Patent Application Publication
(10) Pub. No.: US 2011/0257829 A1
(43) Pub. Date: Oct. 20, 2011

(54) METHOD AND DEVICE FOR MONITORING THE TIRE PRESSURE OF MOTOR VEHICLE TIRES

(76) Inventor: Norbert POLZIN, Zaberfeld (DE)

(21) Appl. No.: 13/079,450

(22) Filed: Apr. 4, 2011

(30) Foreign Application Priority Data
Apr. 14, 2010 (DE) 102010003954.3

(51) Int. Cl. B60C 23/00

(52) U.S. Cl. 701/29

(57) ABSTRACT

A method for monitoring the tire pressure of motor vehicle wheels of which at least one is equipped with a tire pressure sensor. The tire pressure can be very easily monitored even at those wheels not having a tire pressure sensor if, at a first wheel having a tire pressure sensor, the tire pressure or a quantity that is a function of the tire pressure is measured and this measurement value is used as a reference value, and in addition a quantity that is a function of the tire pressure is measured at a second wheel that does not have a tire pressure sensor, and the corresponding measurement value is compared to the reference value.

### BACKGROUND INFORMATION

In order to monitor the pressure of motor vehicle tires, it is known to equip all the wheels of the motor vehicle with pressure sensors that supply a pressure measurement signal to a control device. The transmission of the measurement signals standardly takes place via radio. The pressure sensors can for example be built into the valves of the tires. Such a system is relatively elaborate and expensive, because all the wheels have to be provided with corresponding pressure sensors. Moreover, each individual pressure sensor must be supplied with electrical energy by battery.

Another method known from the prior part makes use of the fact that the rolling circumference of a wheel changes with the tire pressure. Wheels having lower tire pressure are somewhat smaller and therefore display a somewhat higher wheel velocity. In order to monitor the tire pressure, wheel rotational speed sensors are used to measure and integrate the difference between two wheel velocities. As soon as the integral exceeds a prespecified threshold, a pressure loss at a wheel is inferred. However, using this method a pressure loss can be determined only the two tires are losing air to different extents. If, in contrast, both tires are losing air to the same extent, the pressure difference remains the same in magnitude, so that this measurement method does not work. In order to enable pressure monitoring even in the case of equal pressure loss, it is known to additionally evaluate the natural frequency of the individual wheels. This measurement method is based on the fact that the natural frequency of a wheel shifts when there is a loss of pressure. The natural frequencies of the individual wheels are determined from the individual wheel rotational speeds using fast Fourier transformation (FFT). In this way, a simultaneous slow-acting loss of pressure at all four wheels can be recognized. However, the FFT approach has the disadvantage that it is very computationally intensive. For this reason, a calculation using Kalman filtering is preferably used.

In the above-named indirect measurement methods (change in rolling circumference/shift in natural frequency), it is necessary to initialize the measurement in order to signal to the system that an error-free state is present, e.g. after a tire change. For this purpose, for example a pushbutton is provided in the dashboard of the vehicle. After the initialization, during the first kilometers of travel the monitoring system learns the initial state (target values), making the assumption that the tire pressure is correct at all wheels. These trained values are then stored in the EEPROM. Subsequently, a comparison of target and actual values is then permanently carried out. However, it is also possible for the driver to actuate the pushbutton when the pressure in the tires is too low, if for example the warning signal of the tire pressure monitoring system is disturbing to the driver. In this case, the system is reset and the warning signal is deactivated even though the tires contain too little air. In this case, the monitoring then begins from a too-low pressure level. This is critical with regard to driving safety.

### SUMMARY OF THE INVENTION

It is therefore an object of the present invention to provide a method and a device for tire pressure monitoring that are particularly simple and economical and that moreover cannot be disregarded by the driver.

According to the present invention, it is provided to equip at least one wheel, but not all wheels, of the vehicle with a tire pressure sensor and to measure, at a first wheel having a tire pressure sensor, the tire pressure or a quantity that is a function of the tire pressure, such as for example the wheel rotational speed, the wheel natural frequency, or the rolling circumference of the wheel, and to use the measurement value as a reference value for monitoring the tire pressure at a second wheel that does not have a tire pressure sensor. In addition, the present invention provides that a quantity that is a function of the tire pressure be measured at a second wheel and that this measurement value be compared to the reference value. If a determined condition is met, a loss of pressure is inferred and a corresponding warning signal is produced. A loss of pressure can for example be inferred if the difference between the measurement value at the second wheel and the reference value has become so large during driving operation that a prespecified threshold has been exceeded. Thus, using the system according to the present invention for monitoring tire pressure it is no longer necessary to equip all wheels with a tire pressure sensor, so that the monitoring of the tire pressure becomes significantly less expensive.

Preferably, only a single wheel is provided with a tire pressure sensor.

Preferably, the tire pressure is measured continuously, or at least at regular intervals, at those wheels that are equipped with a tire pressure sensor. In this way, a loss of pressure at one of these wheels can be recognized immediately.

According to a specific embodiment of the present invention, it is necessary to initialize the monitoring system. For the initialization, a sensor, such as for example a pushbutton, can be provided that has to be actuated by the driver after the tires have been filled with air or a tire change has been carried out. The tire pressure monitoring according to the present invention is then carried out under the assumption that the pressure in the tires not having a tire pressure sensor is correct at the time of the initialization. Therefore, actuation of the sensor indicates to the monitoring system according to the present invention that a state is present in which the tire pressure is correct at all wheels, and on the basis of which the monitoring is to be carried out.

The reference value and the quantity that is a function of tire pressure are preferably measured continuously or at regular intervals.

As soon as a loss of pressure at a wheel has been determined, an optical or acoustic warning signal is preferably outputted to the driver. For this purpose, for example a warning light in the dashboard can be activated.

In order to prevent the driver from misusing the above-named sensor to reset the monitoring system, a condition can be defined that has to be met in order to make it possible to reset the system. Thus, for example it can be provided that the system is capable of being reset or initialized only if the difference between the measurement value and the reference value is smaller than a threshold value. If, in contrast, the difference is greater than the specified threshold value, the monitoring system preferably then cannot be reset.

Moreover, according to a preferred specific embodiment of the present invention it is provided that a temperature compensation of at least one of the measurement signals is carried out. In this case, a temperature sensor is required that for example can also be situated in a tire. The tire pressure sensor and the temperature sensor can be integrated in an electronic circuit. With the aid of the temperature compensation, a loss of pressure at one of the wheels can be determined with still greater precision.

### BRIEF DESCRIPTION OF THE DRAWINGS

FIG. 1 shows a schematic top view of a vehicle equipped with a tire pressure monitoring system.

FIG. 2 shows the important method steps of a method for tire pressure monitoring.

### DETAILED DESCRIPTION

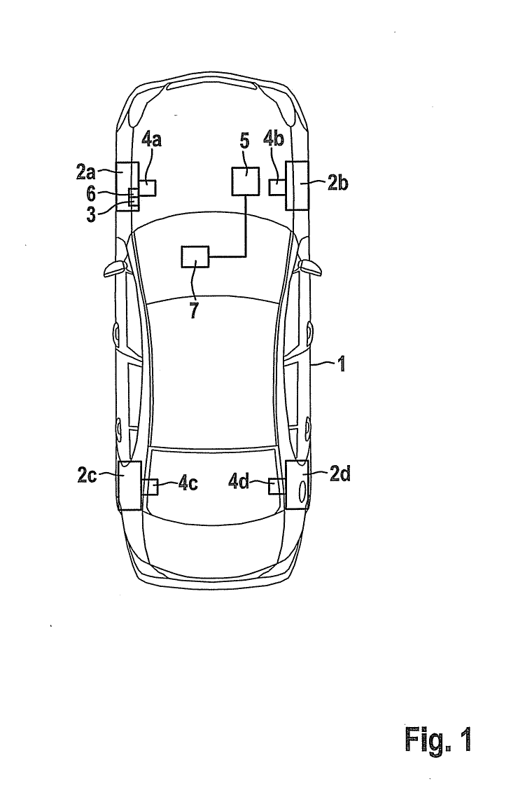

FIG. 1 shows a top view of a vehicle 1 that has four wheels 2a, 2b, 2c, 2d and that is equipped with a system for tire pressure monitoring. One of the wheels, in this case 2a, has for this purpose a tire pressure sensor 3. The remaining wheels 2b, 2c, 2d do not have a tire pressure sensor 3.

The signal measured by tire pressure sensor 3 is transmitted by radio to a control device 5 and is processed there. For the temperature compensation of the measurement signal, a temperature sensor 6 is optionally provided that is also situated in wheel 2a. The signal of temperature sensor 6 is also transmitted by radio to control device 5. Control device 5 includes an algorithm that carries out a temperature compensation and that correspondingly corrects the tire pressure or some other measurement quantity that is a function of pressure. Vehicle 1 also has four wheel rotational speed sensors 4a, 4b, 4c, 4d—one per wheel.

In order to monitor the tire pressure at those wheels that do not have a tire pressure sensor, the following method can be carried out:

The monitoring of the tire pressure begins with the initialization of the system. For this purpose, in the present example a button 7 is provided that has to be pressed by the driver after filling of the wheels 2a, 2b, 2c, 2d, or after a tire change has been carried out. The monitoring system then assumes that a state is present in which the tire pressure is correct at all wheels.

After the actuation of button 7, the tire pressure and/or a quantity that is a function of tire pressure is measured at wheel 2a, which has a tire pressure sensor 3. This quantity can be for example the wheel rotational speed or wheel velocity, the natural frequency of the wheel, or the rolling circumference of the wheel. The named quantities can all be determined from the measurement signal of rotational speed sensor 4a.

According to a first specific embodiment of the present invention, the measurement value that is a function of tire pressure, such as for example the rolling circumference, is used as a reference value for monitoring the tire pressure at the other wheels 2b, 2c, 2d. The quantity that is a function of tire pressure is also measured at the other wheels 2b, 2c, 2d and is compared to the reference value.

According to another specific embodiment, the tire pressure measured at wheel 2a is used directly as a reference value. In this case, a quantity that is a function of tire pressure is measured at wheels 2b, 2c, or 2d and a particular tire pressure is assigned to the measurement quantity (i.e., the measurement quantity is converted to a tire pressure). The tire pressure estimated in this way is then compared to the reference value.

After the initialization, an initial difference Δ₀ is determined for each wheel 2b, 2c, 2d, said difference characterizing the initial deviation of the quantity determined at wheels 2b, 2c, 2d from the reference quantity. As driving operation continues, monitoring then takes place of the manner in which the quantities measured at wheels 2b, 2c, 2d change in relation to the reference quantity measured at wheel 2a. If, for example, the currently measured difference Δ between a measurement quantity and the reference quantity deviates from the initial value Δ₀ by an amount greater than a prespecified threshold value SW, a loss of pressure is recognized at the relevant wheel 2b, 2c, 2d, and a warning signal is produced. In this case, the condition is: Δ−Δ₀>SW.

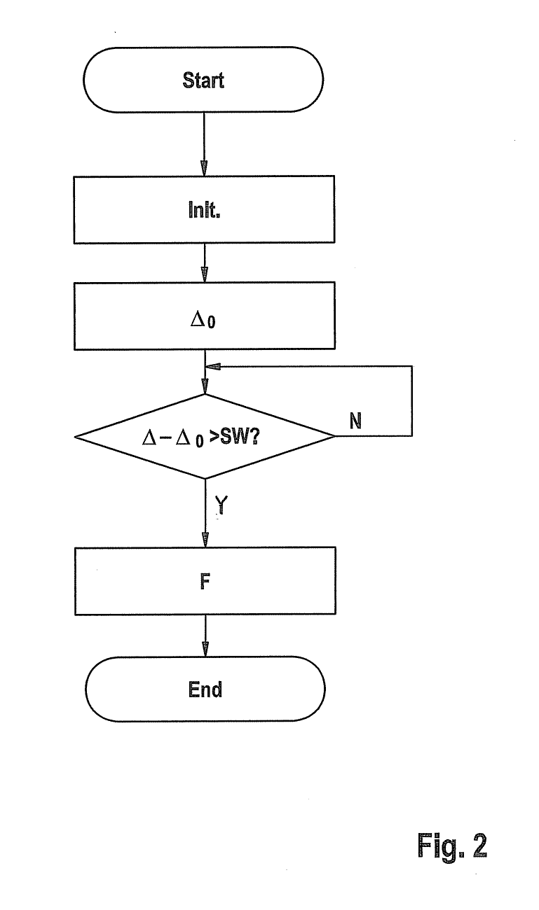

FIG. 2 again shows the important steps of a method according to the present invention for monitoring tire pressure. The monitoring system is first initialized by actuating button 7 (step 10). In a subsequent training phase, a reference value is then measured, such as for example the rolling circumference of tire 2a and the corresponding measurement quantity at the other wheels 2b, 2c, 2d. For each of the wheels 2b, 2c, 2d there results a certain deviation from the reference value, stored as initial deviation Δ₀ for each of the wheels 2b, 2c, 2d (step 11). If, during further driving operation, one of the wheels 2b, 2c, 2d loses air, the deviation Δ of the measurement quantity from the reference value changes.

In step 12, it is queried whether the deviation Δ, compared to initial deviation Δ₀, is greater than a prespecified threshold value SW. If no (N), monitoring of the tire pressure continues. Otherwise (Y), a warning signal is outputted in step 13. Here, threshold value SW can be a function of the tire pressure measured at wheel 2a.

With this method, a pressure loss can be recognized even if all wheels 2a, 2b, 2c, 2d are losing air equally, because in this case a pressure signal of pressure sensor 3 is available.

What is claimed is:

1. A method for monitoring the tire pressure of motor vehicle tires of which at least one is equipped with a tire pressure sensor, the method comprising:
measuring the tire pressure or a quantity that is a function of the tire pressure at a first wheel that has a tire pressure sensor;
using a measurement value as a reference value for the monitoring of the tire pressure at another wheel;
measuring a quantity that is a function of the tire pressure at a second wheel that does not have a tire pressure sensor; and
determining a loss of pressure at the second wheel if a condition is met that is a function of the quantity measured at the second wheel and of the reference value.

2. The method according to claim 1, wherein a loss of pressure is determined at the second wheel if a difference between the quantity measured at the second wheel and the reference value exceeds a prespecified threshold.

3. The method according to claim 1, wherein the quantity that is a function of the tire pressure is a wheel rotational speed, a wheel circumference, or a wheel natural frequency.

4. The method according to claim 1, wherein the quantity that is a function of the tire pressure is measured using a wheel rotational speed sensor.

5. The method according to claim 1, wherein the method for tire pressure monitoring is initialized by actuating a sensor.

6. The method according to claim 1, wherein a measurement signal supplied by the tire pressure sensor is temperature-compensated.

7. A control device for monitoring the tire pressure of motor vehicle tires of which at least one is equipped with a tire pressure sensor, the control device comprising:
means for measuring the tire pressure or a quantity that is a function of the tire pressure at a first wheel that has a tire pressure sensor;
means for using a measurement value as a reference value for the monitoring of the tire pressure at another wheel;
means for measuring a quantity that is a function of the tire pressure at a second wheel that does not have a tire pressure sensor; and
means for determining a loss of pressure at the second wheel if a condition is met that is a function of the quantity measured at the second wheel and of the reference value.

8. A device for monitoring the tire pressure of motor vehicle tires, comprising:
a number of tire pressure sensors, the number being less than a total number of wheels;
a plurality of wheel rotational speed sensors; and
a control unit that processes a measurement signal of a tire pressure sensor and/or a wheel rotational speed sensor of a first wheel that is equipped with a tire pressure sensor, that processes a measurement signal of a wheel rotational speed sensor of a second wheel that does not have a tire pressure sensor, and that determines therefrom whether a loss of pressure has occurred at the second wheel.
